(19) United States
(12) Patent Application Publication
(10) Pub. No.: US 2013/0235557 A1
(43) Pub. Date: Sep. 12, 2013

(54) LED LIGHT SOURCE AND ASSOCIATED STRUCTURAL UNIT

(71) Applicants: Stefan Hadrath, Falkensee (DE); Julius Muschaweck, Gauting (DE); Frank Baumann, Regensburg (DE); Henrike Streppel, Regensburg (DE)

(72) Inventors: Stefan Hadrath, Falkensee (DE); Julius Muschaweck, Gauting (DE); Frank Baumann, Regensburg (DE); Henrike Streppel, Regensburg (DE)

(73) Assignee: OSRAM GMBH, Muenchen (DE)

(21) Appl. No.: 13/880,745

(22) PCT Filed: Oct. 22, 2010
(86) PCT No.: PCT/EP2010/065945

§ 371 Date: May 28, 2013

(51) Int. Cl. F21V 9/16

(52) U.S. Cl. CPC F21V 9/16
USPC 362/84

(57) ABSTRACT

An LED light source includes a primary light source, in particular at least one blue- or UV-emitting semiconductor chip, the radiation of which is converted partly or completely into longer-wave radiation by a conversion element fitted at a distance, said conversion element being disposed as a dome ahead of the primary light source, wherein the dome is a section of an oblate body having an equator and a pole, wherein the pole points in the direction of the optical axis, wherein the oblate body is flattened in the direction toward the pole relative to the direction toward the equator, and wherein the oblate body is equipped with a converting phosphor layer.

### RELATED APPLICATIONS

The present application is a national stage entry according to 35 U.S.C. §371 of PCT application No.: PCT/EP2010/065945 filed on Oct. 22, 2010.

### TECHNICAL FIELD

Various embodiments relate to an LED light source. Various embodiments furthermore also relate to an associated structural unit, a module or luminaire, including such an LED light source.

### BACKGROUND

An LED light source in which a dome comprising phosphor is spanned over an LED array is previously known from U.S. Pat. No. 7,758,223.

WO 2010/089397 discloses an LED light source including a dome shaped as a section of a sphere with a solid angle of greater than 2π.

### SUMMARY

Various embodiments provide an improved concept for an LED light source. Various embodiments provide an LED light source, in particular an LED-based luminous means such as e.g. an LED retrofit lamp, in which a particularly high optical efficiency (measured in lumens per electrical watt) in conjunction with a large emission angle and little color variation over the emission angle is achieved by means of a geometrically particularly advantageous arrangement of the phosphor.

LED light sources, in particular LED retrofit lamps, are nowadays realized as standard with an LED array, a specific number of white LEDs, mounted on a printed circuit board. In one customary embodiment, the wavelength conversion of a blue-emitting LED chip based on InGaN, said conversion being necessary for generating white light, takes place in the LED and thus near the chip. Typically, the conversion element containing the phosphor or phosphors is applied directly on the chip. In another embodiment, the so-called “remote phosphor” concept, by contrast, the phosphor is spatially separated significantly from the blue LEDs; depending on the embodiment, the distance is typically 0.5 to 10 cm, in particular 1.5 to 5 cm. The prior art here involves an embodiment including a dome-shaped conversion element of simple geometry, for example a sphere segment having a constant shell thickness, within an outer, diffuse lamp bulb, and embodiments in which the phosphor is applied directly on the outer, transparent bulb.

Various embodiments present a novel geometrical design of the conversion element designed in the remote phosphor configuration. In this case, the following points are important:

On the basis of the exemplary embodiment of a sphere, instead of a hemisphere a larger sphere section is used, that is to say a sphere section having a total height h that is greater than the radius r of the sphere, that is to say h>r. In this case, h is approximately 1.2 to 1.8 times r. This relation also holds true for particularly preferred hollow bodies described below.

The hollow body is preferably a section of an ellipsoid or other elliptical body, in particular an oblate in the mathematical sense of the word, that is to say a hollow body flattened at its poles. It may also have a freeform surface, in particular a surface shaped in a mushroom-like manner.

The LED light source together with remote phosphor dome is placed in particular onto a base or other electrical and thermal connection element or may be connected thereto.

The layer thickness of the conversion element is designed to be variable in order to improve the color homogeneity over the emission angle.

One advantage afforded is an increase in the optical efficiency, brought about firstly by the larger radius of the phosphor dome in comparison with a sphere and secondly by the change in shape to an oblate body. A further advantage is the increase in the maximum emission angle owing to the use of an oblate body and a larger dome section.

An improvement in the color over angle distribution is advantageously achieved by means of different layer thicknesses of the phosphor in the region of the dome.

In one preferred embodiment, there are two regions of different optical thicknesses of the dome, that is to say of the oblate body. It is particularly preferred to use more than two regions of different layer thicknesses. The change in layer thickness can take place in a stepped manner or continuously.

This results in a typical improvement in the optical efficiency of approximately 10 to 20%.

Compared with embodiments having phosphor on the outer bulb, in one preferred construction including an outer enclosure, that is to say an inner dome as conversion element and an outer enclosure as diffuser, a more appealing appearance of the light source in the switched-off state is achieved. In particular, a lamp bulb of an LED lamp in the switched-off state does not appear yellow. However, the use of an outer enclosure as diffuser shell is technically not necessary.

In particular, the following conditions are advantageous:

The oblate body is rotationally symmetrical. It is disposed ahead of an LED array. The oblate body is, in particular, an ellipsoid having one minor semi-axis a and two major semi-axes b=c. The height h of the oblate body is at least 1.1 times a, that is to say h≧1.1a. It is preferably the case that 1.1a≦h≦1.8a. Alternatively, the oblate body may also be a freeform body or a mushroom body, in a manner similar to that in FIG. 7 of U.S. Pat. No. 7,758,223 (although with a totally different function therein, because the dome therein is only the outer shell having a reflective lower part and transmissive upper part, with no conversion from blue to white taking place).

In this case, the base diameter of the oblate body is larger than the actual LED array. The oblate body has a pole, which passes through the axis of symmetry of the oblate body, and an equator.

Preferably, the oblate body is composed of silicone, polycarbonate, glass or translucent ceramic or else plastic such as plexiglass. In this case, one or more phosphors are either dissolved in the oblate body or applied as a layer to the wall of the oblate body, preferably on the inside.

Advantageously, the layer thickness of the phosphor layer of the oblate body is not constant, but rather varies. A typical value is that the layer thickness or concentration of the phosphor decreases by 10 to 20% from the pole toward the outside.

In the simplest exemplary embodiment, there are two regions having a different optical thickness k, realized by a different concentration c and/or a different layer thickness d, where k=cd. In this case, in particular, by way of example, the thickness of the phosphor layer or the thickness of the wall in which a phosphor is dispersed can change.

A frontal, first region, including the pole, of the dome has in particular a layer thickness that is at least 5% higher than the layer thickness in a dorsal, second region, arranged at a distance from the pole. Continuous transitions are possible, but stepped transitions are easier to produce. The difference in the optical thickness depends inter alia on the phosphor mixture, the geometry, the blue LEDs used, etc.

In the simplest case, the frontal region is the complete half-shell with a solid angle of 2π, which includes the pole, while the dorsal region is the remaining region of the oblate body. However, it may also be advantageous if the frontal region spans a different solid angle, be it an appreciably larger or else smaller solid angle, depending on the geometry of the hollow body.

The phosphor preferably used is a yellow-emitting phosphor such as YAG:Ce, other garnets, sialons or orthosilicates, which together with a blue-emitting LED mix to form white. However, RGB solutions comprising red- and green-emitting phosphors and a blue LED are also possible. Moreover, embodiments including a UV-LED, in particular with blue-yellow conversion or comprising red-, green- and blue-emitting phosphors, are also possible.

The change in the optical thickness, in particular the concentration of the phosphor, can be realized in three ways, in principle:
separate layer composed of phosphor, having two regions of different thicknesses;
dispersion of the phosphor in the oblate body with an identical concentration of the phosphor in the oblate body, but a different wall thickness in at least two regions;
dispersion of the phosphor in the oblate body with a different concentration of the phosphor in the oblate body in at least two regions of the oblate body, but with a constant wall thickness of the oblate body.

The LED array is preferably arranged such that the LEDs are arranged in a circular fashion around a central point that forms the optical axis. If appropriate, an LED can also be arranged at the central point itself.

The primary light source is a semiconductor chip, also realized, if appropriate, as an LED or laser diode or chip-on-board, which preferably emits UV or blue, preferably in a range of 300 to 500 nm peak emission.
An LED light source includes a primary light source, in particular at least one blue- or UV-emitting semiconductor chip, the radiation of which is converted partly or completely into longer-wave radiation by a conversion element fitted at a distance, said conversion element being disposed as a dome ahead of the primary light source, characterized in that the dome is a section of an oblate body having an equator and a pole, wherein the pole points in the direction of the optical axis, wherein the oblate body is flattened in the direction toward the pole relative to the direction toward the equator, and wherein the oblate body is equipped with a converting phosphor layer.
In a further embodiment, the LED light source is configured such that the oblate body is a section of an ellipsoid, having a minor demi-axis a pointing in the direction toward the pole.
In a still further embodiment, the oblate body spans a solid angle of greater than 2π, in particular 2.5π to 3.5π.
In a still further embodiment, the oblate body is subdivided into at least two regions, wherein a frontal region, which encloses the pole, has a higher optical thickness than a dorsal region adjacent thereto in the direction of higher emission angles.
In a still further embodiment, the frontal region has a maximum emission angle, calculated from the pole, of 70° to 110°.
In a still further embodiment, the dorsal region has a maximum emission angle, calculated from the pole, of 130° to 160°.
In a still further embodiment, the LED light source has a connection element having a pedestal and a reflective baseplate and thus forms an assembly whose base area is larger than the base area of the dome.
In a still further embodiment, the optical thickness of the phosphor is varied either by virtue of the fact that the layer thickness of a phosphor layer applied on the wall of the dome is chosen to be different, or by virtue of the fact that the phosphor is dispersed in the dome, wherein either the concentration of the phosphor in the wall of the dome is constant and in this case the wall thickness is different in at least two regions of the dome, or that the phosphor is dispersed in the dome, wherein the concentration of the phosphor in the wall of the dome is different in at least two regions of the dome and in this case the wall thickness of the dome is constant.
In a still further embodiment, one or a plurality of phosphors are used, with an identical change in the optical thickness.
A structural unit includes an LED light source, characterized in that the structural unit is a luminaire or an LED module.

### BRIEF DESCRIPTION OF THE DRAWINGS

In the drawings, like reference characters generally refer to the same parts throughout the different views. The drawings are not necessarily to scale, emphasis instead generally being replaces upon illustrating the principles of the invention. In the following description, various embodiments of the invention are described with reference to the following drawings, in which:

FIG. 1 shows an LED light source, first exemplary embodiment;

FIG. 2 shows an LED light source, second exemplary embodiment;

FIGS. 3A to 3F shows various LED light sources in accordance with FIGS. 3A to 3F in comparison;

FIG. 4 shows the color temperature and the color rendering index of the embodiments in accordance with FIGS. 3A to 3F;

FIG. 5 shows the optical efficiency and the maximum emission angle of the embodiments in accordance with FIGS. 3A to 3F;

FIG. 6 shows the radiant intensity as a function of the emission angle for the embodiments in accordance with FIGS. 3A to 3F;

FIGS. 7A to 7C show various realizations for a different optical thickness, FIGS. 7A to 7C;

FIGS. 8A and 8B show the color coordinates of the embodiments in accordance with FIGS. 3E and 3F;

FIG. 9 shows an exemplary embodiment of an LED module;

FIG. 10 shows a detail illustration of the LED module with centroid of the light and definition of the emission angle;

FIG. 11 shows the optical thickness/concentration of the phosphor as a function of the emission angle for some exemplary embodiments;

FIG. 12 shows the optical thickness/concentration of the phosphor as a function of the emission angle for a further exemplary embodiment;

FIG. 13 shows the scattering behavior of an LED light source;

FIG. 14 shows a further exemplary embodiment of an LED light source;

FIGS. 15A to 15C show further exemplary embodiments of LED light sources;

FIG. 16 shows a further exemplary embodiment of an LED light source;

FIG. 17 shows the radiant intensity of the exemplary embodiment from FIG. 16 compared with an exemplary embodiment having a constant wall thickness of the dome.

### DETAILED DESCRIPTION

The following detailed description refers to the accompanying drawings that show, by way of illustration, specific details and embodiments in which the invention may be practiced.

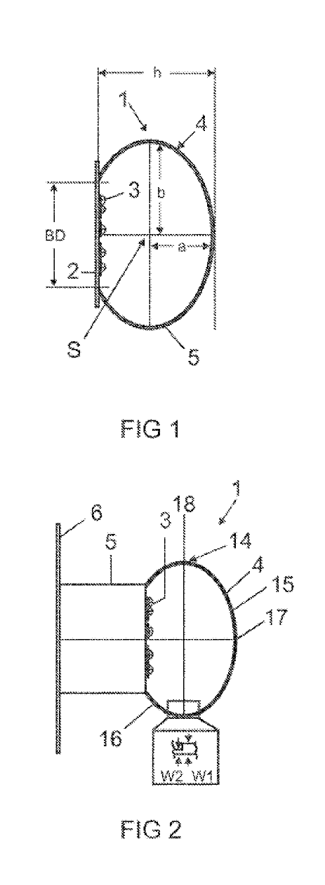

One exemplary embodiment of an LED light source is shown in FIG. 1. This involves a structural unit 1 including an LED array 2 having a set of blue LEDs 3. An oblate body 4 is placed directly onto the LED array, and spans the LED array in a dome-like manner. A phosphor, here a mixture of yellow-green-emitting Lu-containing garnet and a red-emitting nitridosilicate, is dispersed uniformly in the wall of the oblate body.

The oblate body is an ellipsoid. It has one minor semi-axis a, which is perpendicular to the LED array, and one major semi-axis b, which is spanned rotationally symmetrically with respect to the semi-axis a.

In one specific exemplary embodiment, the layer thickness of the phosphor, and thus the wall thickness, is 0.5 mm. The oblate body has the dimensions a=15 mm, b=22 mm and h=27 mm. The base diameter BD of the dome then clearly defines a base area by means of the variables a, b and h.

FIG. 2 shows one particularly preferred exemplary embodiment, the geometry of which corresponds in essential parts to that of FIG. 1. In this case, an electrical connection part 5 having a reflective surface and a reflective baseplate 6 (here realized as a PCB) are attached to the LED array 3 at the rear. The oblate body is subdivided into two regions having different wall thicknesses. The frontal region 15 has a wall thickness W1 of 0.5 mm, and the dorsal region 16 has a wall thickness W2 of 0.43 mm. In this case, the frontal region extends from the pole 17 to the equator 18 of the oblate body. The solid angle of the frontal region here is 2π and the transition from the frontal to the dorsal region is stepped. The reflective baseplate 6 and connection part 5 improve the efficiency of the structural unit.

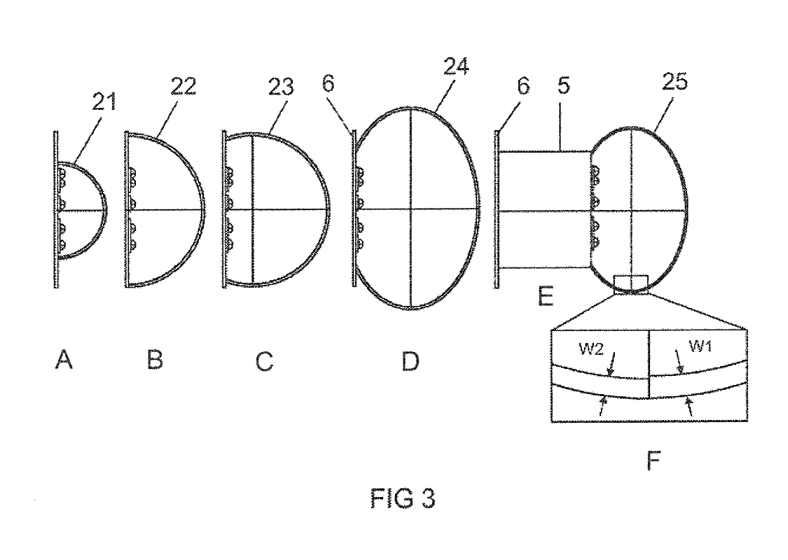

FIGS. 3A to 3F show an overview of various forms of a dome equipped with phosphor.

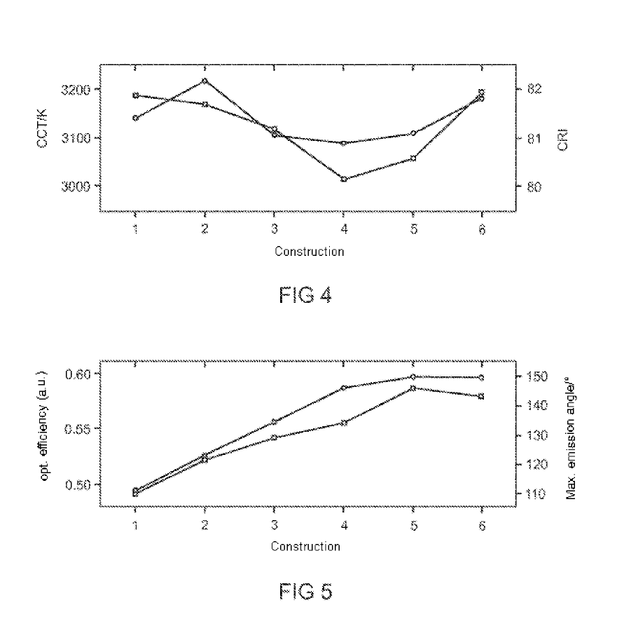

FIG. 3A shows a dome as a half sphere section having a radius of r=10.5 mm. The color temperature is indicated in FIG. 4 with approximately 3200 K. The Ra or CRI is indicated as right ordinate (dashed curve). However, the efficiency according to FIG. 5 is very low and the emission angle (right ordinate/dashed curve) is very small.

FIG. 3B shows a dome as a half sphere section having a radius of r=17 mm. The efficiency is higher here owing to the larger diameter of the base of the dome.

FIG. 3C shows a dome as a sphere section where r=17 mm, but having an increased solid angle of approximately 3π. The efficiency here is higher again than in FIG. 3B owing to the larger solid angle of the dome.

FIG. 3D shows a dome with an oblate body according to the invention. Here, owing to the solid angle of the dome that is higher again, the efficiency is higher again than in FIG. 3C and the emission angle is significantly increased again.

FIG. 3E shows a dome with an oblate body according to the invention; in this case, the LED light source is mounted on a pedestal and with a reflective main body. Here, owing to the reflective main body and pedestal, the efficiency is higher again than in FIG. 3E and the emission angle is somewhat higher again.

FIG. 3F refers to the same arrangement as FIG. 3E, but with the difference that the dome is subdivided into two regions having a different wall thickness W1 and W2, in which the optical thickness of the phosphor is different. In this exemplary embodiment, the efficiency and the maximum emission angle remain approximately the same, compared with the exemplary embodiment in accordance with FIG. 3E.

However, the difference between the exemplary embodiment in accordance with FIG. 3E and FIG. 3F is expressed in the next figures.

FIG. 4 shows the color temperature and the CRI exhibited by different realizations, including the two embodiments in FIG. 1 or 2.

FIG. 5 shows the optical efficiency of the exemplary embodiments in a comparison. It is significantly higher in the case of the construction in accordance with FIG. 2.

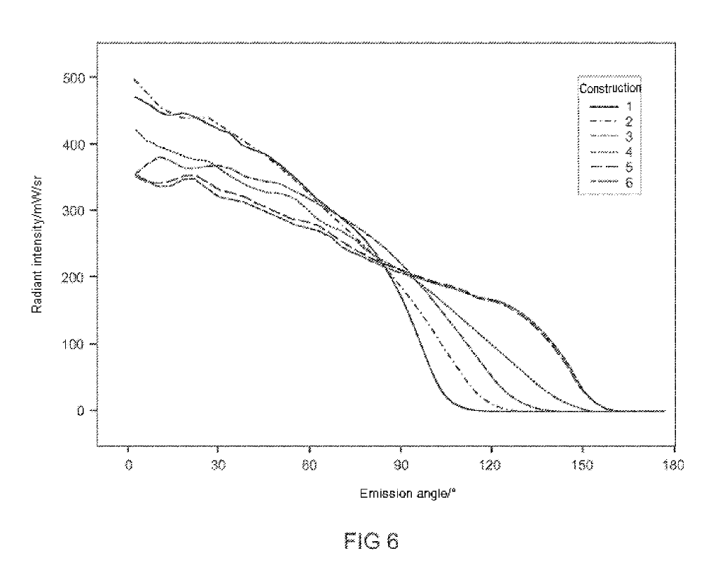

FIG. 6 shows the radiant intensity in mW/sr for the various embodiments in FIGS. 3A to 3F as a function of the emission angle (the pole is calculated as an angle with 0°). Illumination that is as uniform as possible over a large emission angle can be achieved only with the embodiments according to the invention.

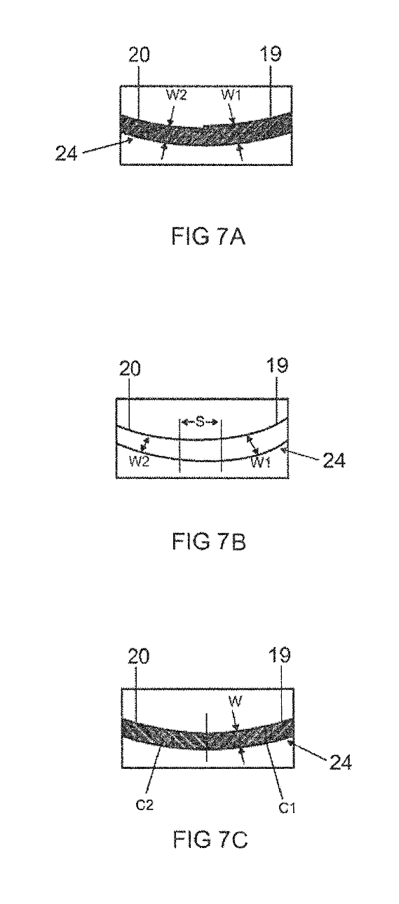

FIGS. 7A to 7C show various exemplary embodiments of the realization of different regions of the dome with a different phosphor concentration or optical thickness.

FIG. 7A shows a detail of an oblate body 24 containing two regions of different thickness with the same concentration of the phosphor as a dispersion in the material of the oblate body. The transition is stepped.

FIG. 7B shows a detail of an oblate body 24 containing two regions of different thickness with the same concentration of the phosphor as a dispersion in the material of the oblate body. The transition is fluid or continuous between the frontal region 19 and the dorsal region 20. The transition section s here is approximately as long as the wall thickness W of the frontal region; it can be, in particular, in the range of 0.5 to 3 W1.

FIG. 7C shows a detail of an oblate body 24 containing two regions having a different concentration of the phosphor as a dispersion in the material of the oblate body. The concentration in the frontal region is approximately 15% higher than that in the dorsal region.

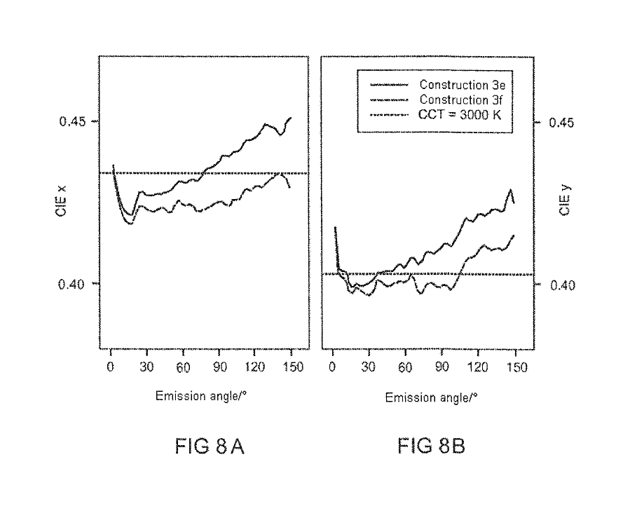

FIGS. 8A and 8B show the color coordinates x and y (in the CIE system from 1931) as a function of the emission angle for the exemplary embodiments in accordance with FIGS. 3E and 3F. The color homogeneity is significantly better in the case of the construction in accordance with FIG. 3F than in the case of the construction in accordance with FIG. 3E.

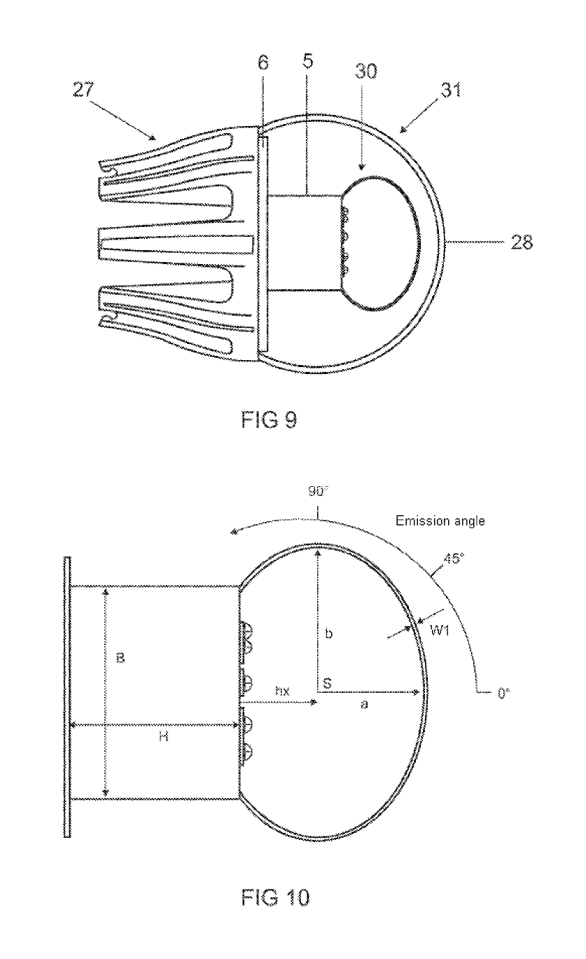

FIG. 9 shows an LED module, including an LED light source as described above, adjoined by a pedestal 25, and a circuit board as baseplate 26. Heat sinks as lamellae 27 are fitted to the baseplate at the rear (also see WO 2010/089397). In addition, a milky dome 17 as diffuser is placed around the LED light source on the outside.

FIG. 10 shows the same arrangement (without heat sinks) with a definition of the emission angle.

In general terms, the concentration of the phosphor particles is intended to change as a function of the emission angle, to be precise in such a way that the concentration is higher in the case of a small emission angle (proceeding from 0°) than in the case of a high emission angle. The latter is calculated from the midpoint S of the oblate body, where the semi-axes intersect. The concentration can be realized as a dedicated phosphor layer on a dome with a constant wall thickness or as a dispersion in the wall of the oblate body. The following holds true here: the partial height hx=h−a.

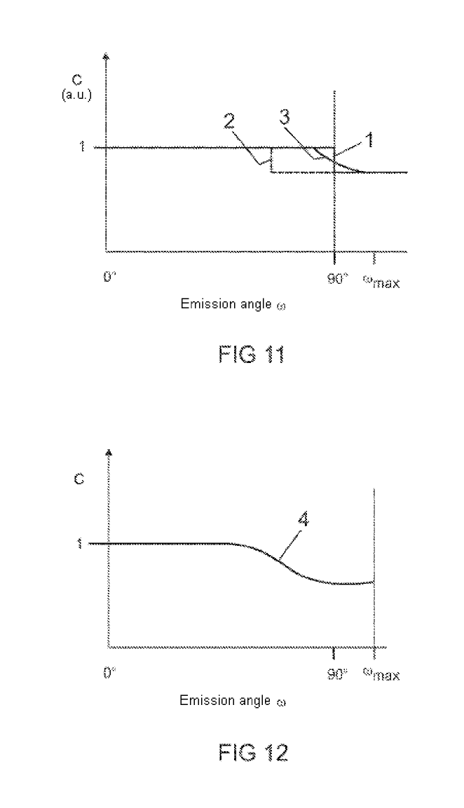

FIG. 11 shows the basic concept of a change in the concentration of the phosphor particles as a function of the emission angle ω as far as the maximum angle ωₘₐₓ. The simplest embodiment is a step, which should lie in a range of the emission angle ω of 70 to 100°; two variants are depicted as curve 1 and 2. Also shown is a further exemplary embodiment with a continuous linear transition over an emission angle of 10°, curve 3, centered on 90°.

FIG. 12 shows an exemplary embodiment of an optimized nonlinear transition of the concentration of the phosphor, said concentration being curved. A stepped transition suffices for most applications, however, because the light is already emitted in a diffusely scattered manner anyway and the human eye cannot resolve the step.

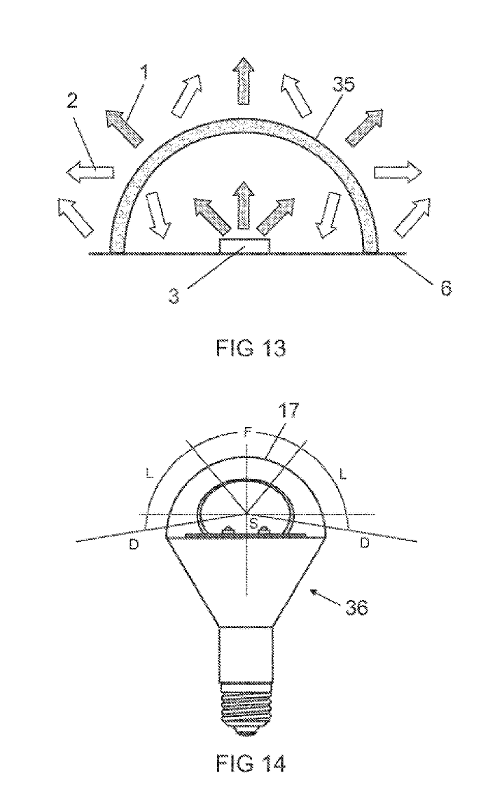

FIG. 13 shows the basic problem for such LED light sources. The LED 3 emits blue light (arrows 1) as primary radiation. Part of the blue light passes through the dome 35, and is scattered in the process. A small part of the blue light is backscattered from the phosphor dome 35. A third portion of the blue light is converted to longer-wave light, assumed to be yellow here, by the phosphor. This yellow light (arrows 2) is emitted uniformly in all directions. The converted yellow light and the transmitted blue light in total produce white light. By way of example, YAG:Ce is used for generating the yellow light.

However, this white light does not have exactly the same color from all angles. The reason for this is that the blue light is more intensive in a forward direction than toward the side; it therefore has a higher light intensity in a forward direction. This effect is weakened, but not canceled, by the scattering at the phosphor. Since the converted yellow light is non-directional, in total in the center the ratio between blue and yellow light is greater than toward the side. Consequently, the light appears more yellowish toward the side. This effect is intended to be compensated for.

In order to compensate for this, the dome is preferably subdivided into two (as specifically indicated here) or else into several, in particular three to four, regions which have different thicknesses or have different concentrations of phosphor, in order to adapt the intensity of the conversion and thus the ratio of blue to yellow light. The position of the transitions between the regions should be adapted in accordance with the chosen geometry of the dome. In the simplest case, the subdivision into a frontal half-shell plus dorsal remainder is sufficient. The concentration of the phosphor (or optical thickness) here changes in each case by 5 to 10%; it decreases in the direction from frontal to dorsal.

FIG. 14 shows as LED light source an LED retrofit lamp 36 with an actual light source, dome, diffuser, connection element and base. In the simplest case, the subdivision into a frontal half-shell plus dorsal remainder is sufficient. In the case of the three regions shown here, the frontal region F may include the pole 17 up to an emission angle of 50°, this being adjoined by a lateral region L with an emission angle of 50 to 100°, this being adjoined by a dorsal region D with an emission angle of more than 100°. The concentration of the phosphor (or optical thickness) changes here in each case by 10 to 20%; it decreases in the direction from frontal to dorsal.

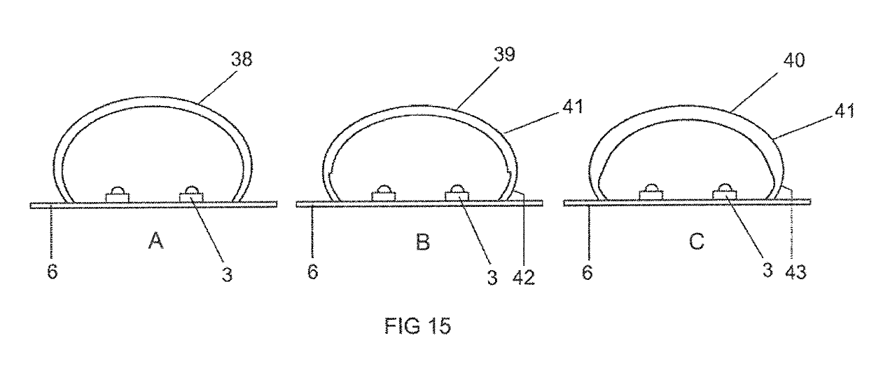

FIGS. 15A to 15C show domes designed as oblate bodies having different thicknesses of the wall.

FIG. 15A shows a continuously decreasing wall thickness of the dome 38, calculated from the pole. The smallest wall thickness is attained at the base body 6.

FIG. 15B shows a wall of the dorsal region 42 of the dome 39, said wall being abruptly reduced in size, wherein the frontal region 41 ends at an emission angle of approximately 80°.

FIG. 15C shows an exemplary embodiment in which the wall thickness of the dorsal region 43 decreases continuously. The dorsal region begins at an emission angle of approximately 85°.

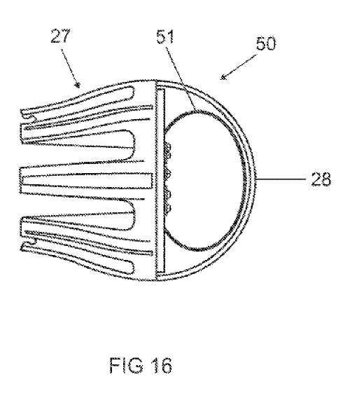

FIG. 16 shows a further exemplary embodiment of an LED light source 50, wherein no pedestal is used. The dome 51 is continued here extremely far in the dorsal region, that is to say that the maximum emission angle is particularly large. Here, a=15 mm, b=22 mm and h=27 mm and the wall thickness is 0.5 and 0.43 mm. The embodiment is similar to that in FIG. 3D, except with a different wall thickness.

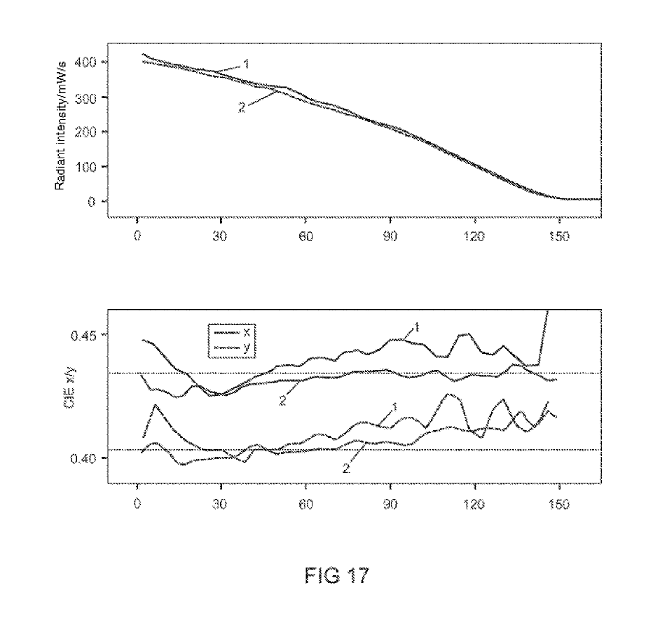

FIG. 17 shows the radiant intensity and the color coordinates x and y for two different exemplary embodiments. Curve 1 shows the behavior of an LED light source in which the wall thickness of the dome is a constant 0.5 mm and the phosphor dispersed therein has a constant concentration. Curve 2 shows the behavior of the LED light source from FIG. 16, in which the wall thickness of the dorsal region is 0.43 mm and thus smaller than the wall thickness of the frontal region with 0.5 mm. The change in the wall thickness leads to a better uniformity of the color coordinates. The base diameter BD is adapted to the values for a, b and h.

Generally, the following configurations, in particular, can be used as chip, if appropriate LED or LED array, for the LED light source:

Blue-emitting chips as primary light source, wherein a partial conversion takes place by means of a phosphor layer at the dome, in which at least one yellow-emitting or at least one green- and red-emitting phosphor is used, wherein at least one of the phosphors is localized at the dome; a white-emitting light source is thus created,

UV-LEDs as primary light source, wherein at least a partial, preferably complete, conversion takes place by means of a phosphor layer at the dome, in which at least one yellow- and one blue-emitting or at least one green -and one red- and one blue-emitting phosphor are used, wherein at least one of the phosphors is localized at the dome; a white-emitting light source is thus created,

LED arrays as primary light source, in which various types of chips are used which at least partly use phosphors in the region of the dome for conversion;

LED arrays as primary light source, in which a first group of chips and a second group of chips are used, wherein at least one group uses a phosphor in the region of the dome for conversion; for example a blue-emitting chip, the light of which is partly converted into green light by a phosphor localized at the dome, such that this system together generates greenish-white or mint-colored light, together with a red-emitting, in particular amber-emitting, chip, the light of which is not converted by the dome;

all kinds of colored LEDs as primary light source, in which for example full conversion is used, for example a blue LED, the light of which is completely converted into green by means of a sion or sialon phosphor;

mood lighting, in which different types of white are generated by suitable coordination of different chips and phosphors, for example warm white through neutral white to daylight-like white.

The phosphors used in each case can be partly or completely localized at the dome, that is to say be applied there as a layer or be introduced in the wall of the dome.

Specific exemplary embodiments are:

An LED lamp with light color warm white, in which blue LEDs, in particular having a peak emission in the range of 430 to 460 nm, are used as an LED array. Two phosphors, which emit red and green, are mixed homogeneously in the dome.

An LED lamp in which warm white is realized by a first group of blue LEDs and a second group of red LEDs, wherein a garnet A3B5012:Ce, in particular a garnet containing yttrium and/or containing lutetium as component A, said garnet simultaneously containing portions of aluminum and gallium for the component B, is introduced in the dome for generating green emission.

An LED lamp in which neutral white or cold white is realized by an array of UV-LEDs, wherein a layer of phosphor is applied on the dome, a blue- and a yellow-emitting phosphor such as BAM and YAG:Ce being mixed in said layer.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An LED light source comprising a primary light source, in particular at least one blue- or UV-emitting semiconductor chip, the radiation of which is converted partly or completely into longer-wave radiation by a conversion element fitted at a distance, said conversion element being disposed as a dome ahead of the primary light source, wherein the dome is a section of an oblate body having an equator and a pole, wherein the pole points in the direction of the optical axis, wherein the oblate body is flattened in the direction toward the pole relative to the direction toward the equator, and wherein the oblate body is equipped with a converting phosphor layer.

2. The LED light source as claimed in claim 1, wherein the oblate body is a section of an ellipsoid, having a minor demi-axis a pointing in the direction toward the pole.

3. The LED light source as claimed in claim 1, wherein the oblate body spans a solid angle of greater than 2π.

4. The LED light source as claimed in claim 1, wherein the oblate body is subdivided into at least two regions, wherein a frontal region, which encloses the pole, has a higher optical thickness than a dorsal region adjacent thereto in the direction of higher emission angles.

5. The LED light source as claimed in claim 1, wherein the frontal region has a maximum emission angle, calculated from the pole, of 70° to 110°.

6. The LED light source as claimed in claim 1, wherein the dorsal region has a maximum emission angle, calculated from the pole, of 130° to 160°.

7. The LED light source as claimed in claim 1, wherein the LED light source has a connection element having a pedestal and a reflective baseplate and thus forms an assembly whose base area is larger than the base area of the dome.

8. The LED light source as claimed in claim 1, wherein the optical thickness of the phosphor is varied either by virtue of the fact that the layer thickness of a phosphor layer applied on the wall of the dome is chosen to be different, or by virtue of the fact that the phosphor is dispersed in the dome, wherein either the concentration of the phosphor in the wall of the dome is constant and in this case the wall thickness is different in at least two regions of the dome, or that the phosphor is dispersed in the dome, wherein the concentration of the phosphor in the wall of the dome is different in at least two regions of the dome and in this case the wall thickness of the dome is constant.

9. The LED light source as claimed in claim 8, wherein one or a plurality of phosphors are used, with an identical change in the optical thickness.

10. A structural unit comprising an LED light source, said LED light source comprising a primary light source, in particular at least one blue- or UV-emitting semiconductor chip, the radiation of which is converted partly or completely into longer-wave radiation by a conversion element fitted at a distance, said conversion element being disposed as a dome ahead of the primary light source, wherein the dome is a section of an oblate body having an equator and a pole, wherein the pole points in the direction of the optical axis, wherein the oblate body is flattened in the direction toward the pole relative to the direction toward the equator, and wherein the oblate body is equipped with a converting phosphor layer, wherein the structural unit is a luminaire or an LED module.

11. The LED light source as claimed in claim 1, wherein the oblate body spans a solid angle of greater than 2.5 π to 3.5π.
